(19) United States
(12) Patent Application Publication
(10) Pub. No.: US 2025/0300753 A1
(43) Pub. Date: Sep. 25, 2025

(54) TIMESTAMPING OF MULTILANE PROTOCOLS

(71) Applicant: Arista Networks, Inc., Santa Clara, CA (US)

(72) Inventors: Liam Toby Warburton, East Ryde (AU); Marc Durrenberger, Belrose (AU); Matthew William Johnston, Helensburgh (AU); Russell Andrew Lowes, Haberfield (AU)

(21) Appl. No.: 18/615,926

(22) Filed: Mar. 25, 2024

(51) Int. Cl. H04J 3/06

(52) U.S. Cl. CPC H04J 3/065; H04J 3/062; H04J 3/0679

(57) ABSTRACT

A method of operating a network device is provided that includes using a first deserializer to receive first data bits via a first data lane and to output a first data block, using a second deserializer to receive second data bits via a second data lane and to output a second data block, generating a first timestamp for the first data block, generating a second timestamp for the second data block, using a first data buffer to receive the first data block and the first timestamp, and using a second data buffer to receive the second data block and the second timestamp. The first and second data buffers can serve as deskew components along a clock domain boundary. The first and second timestamps can be obtained by timestamping an arrival of data at a same point in each of the first and second data lanes before the clock domain boundary.

### BACKGROUND

A computer network can include a plurality of interconnected network devices. A first network device can convey a data stream to a second network device in the network via a multilane protocol. To capture timestamps of specific events of interest on such data streams, the second (receiving) network device has to reconstruct the data stream sufficiently so that the events of interest can be identified to enable corresponding timestamps to be captured.

The point where specific events of interest can be identified tend to be fairly deep in a receiver pipeline of the second network device. For instance, the receiver pipeline can include a clock domain crossing, which, if care is not taken, may introduce temporal uncertainty into the timestamps, which are typically obtained sometime after the clock domain crossing. It is within such context that the embodiments herein arise.

### BRIEF DESCRIPTION OF THE DRAWINGS

FIG. 1 is a diagram of an illustrative network device having input-output ports in accordance with some embodiments.

FIG. 2 is a diagram showing two illustrative network devices communicating via a multilane communications link in accordance with some embodiments.

FIG. 3 is a diagram of illustrative data receiver circuitry having per-lane timestamping in accordance with some embodiments.

FIG. 4 is a diagram showing how timestamping can occur at various points along the receive path in accordance with some embodiments.

FIG. 5 is a flowchart of illustrative steps for operating the circuitry of the type shown in FIGS. 1-4 in accordance with some embodiments.

### DETAILED DESCRIPTION

A technique for improving timestamping accuracy for a network device operating in accordance with a multilane communications protocol is provided. A network device can include a receiver pipeline configured to receive data via a plurality of physical lanes, which feed data bits into corresponding deskew buffers. The method can include timestamping data blocks from each lane earlier in the receiver pipeline before a clock domain crossing. The timestamps can be conveyed in parallel and in alignment with the data blocks through the receiver pipeline until the data blocks from the various lanes have been reassembled and the events of interest can be identified. At this point, the slowest arriving (most recent) timestamp can be selected and forwarded to other downstream components. Handling one or more timestamps in this way can be technically advantageous and beneficial to improve timestamp accuracy regardless of deskew buffers fill levels or physical lanes ordering.

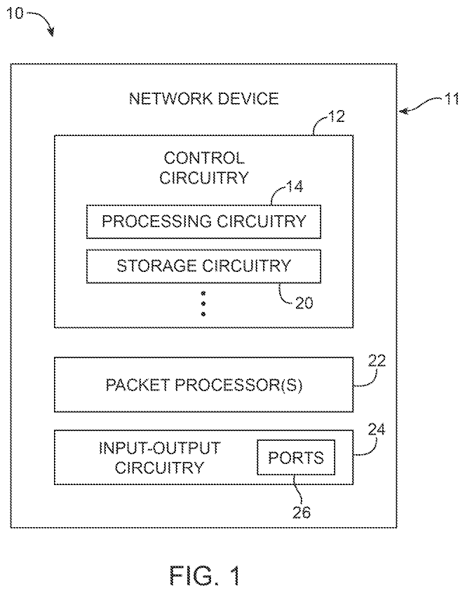

FIG. 1 is a diagram of a network device such as network device 10. Network device 10 may be a switch (e.g., a single-layer (Layer 2) switch or a multi-layer (Layer 2 and Layer 3) switch), a router or gateway, a bridge, a hub, a repeater, a firewall, a wireless access point, a network management device that manages one or more other network devices, a device serving other networking functions, a device that includes a combination of these functions, or other types of network devices.

Network device 10 may include control circuitry 12 having processing circuitry 14 and storage circuitry 20, one or more packet processors 22, and input-output circuitry 24 disposed within a housing 11 of network device 10. The housing 11 may include an exterior cover (e.g., a plastic exterior shell, a metal exterior shell, or an exterior shell formed from other rigid or semi-rigid materials) that provides structural support and protection for the components of network device 10 mounted within the housing. In one illustrative arrangement, network device 10 may be part of a modular network device system (e.g., a modular switch system having removably coupled modules usable to flexibly adjust system capabilities such as adjust the network traffic processing capabilities by changing the number of processors, memory, and/or other hardware components, adjust the number of ports, add or remove specialized functionalities, etc.). In another illustrative arrangement, network device 10 may be a fixed-configuration network device (e.g., a fixed-configuration switch having a fixed number of ports and/or a fixed hardware configuration).

Processing circuitry 14 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other processor architectures. Processing circuitry 14 may run (execute) a network device operating system and/or other software/firmware that is stored on storage circuitry 20.

Storage circuitry 20 may include one or more non-transitory (tangible) computer readable storage media that stores the operating system software and/or any other software code, sometimes referred to as program instructions, software, data, instructions, or code. As an example, network device control plane functions may be stored as (software) instructions on the one or more non-transitory computer-readable storage media (e.g., in portion(s) of memory circuitry 20 in network device 10). The corresponding processing circuitry (e.g., one or more processors of processing circuitry 14 in network device 10) may process or execute the respective instructions to perform the corresponding operations. Storage circuitry 20 may be implemented using non-volatile memory (e.g., flash memory or other electrically-programmable read-only memory configured to form a solid-state drive), volatile memory (e.g., static or dynamic random-access memory), hard disk drive storage, and/or other storage circuitry. Storage circuitry 20 is therefore sometimes referred to as memory circuitry. Processing circuitry 14 and storage circuitry 20 as described above may sometimes be referred to collectively as control circuitry 12 implementing a “control plane” of network device 10.

For example, processing circuitry 14 may execute network device control plane software such as operating system software, routing policy management software, routing protocol agents or processes, routing information base agents, and other control software, may be used to support the operation of protocol clients and/or servers (e.g., to form some or all of a communications protocol stack such as the Transmission Control Protocol (TCP) and Internet Protocol (IP) stack), may be used to support the operation of packet processor(s) 22, may store packet forwarding information, may execute packet processing software, and/or may execute other software instructions that control the functions of network device 10 and the other components therein.

Packet processor(s) 22 may be used to implement a data plane or forwarding plane of network device 10. Packet processor(s) 22 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other processor architectures. Packet processor 22 may receive incoming data packets via input-output circuitry 24, parse and analyze the received data packets, process the packets based on packet forwarding decision data (e.g., data in a forwarding information base) and/or in accordance with network protocol(s) or other forwarding policy, and forward (or drop) the data packet accordingly. The packet forwarding decision data may be stored on a portion of storage circuitry 20 and/or other memory circuitry integrated as part of or separate from packet processor 22.

To interact with external devices, external systems, and/or users, network device 10 may include input-output circuitry 24 formed from corresponding input-output devices, sometimes referred to as interface circuitry. Input-output interface circuitry 24 may include different types of communication interfaces such as Ethernet interfaces (e.g., formed from one or more Ethernet ports), optical interfaces (e.g., formed from removable optical modules containing optical transceivers), Bluetooth interfaces, Wi-Fi interfaces, and/or other network interfaces for connecting device 10 to the Internet, a local area network, a wide area network, a mobile network, generally network device(s) in these networks, and/or other computing equipment (e.g., end hosts, server equipment, user devices, etc.). As an example, some input-output circuitry 24 (e.g., those based on wireless communication) may be implemented using wireless communications circuitry (e.g., antennas, transceivers, radios, etc.).

As another example, some input-output circuitry 24 (e.g., those based on wired communication) may be implemented as physical ports, sometimes referred to as sockets. These physical ports may be configured to physically couple to and/or electrically connect to corresponding mating connectors of external components or equipment (e.g., pluggable optical transceiver modules). Different ports may have different form-factors to accommodate different cables, different modules, different devices, or generally different external equipment. In the example of FIG. 1, input-output circuitry 24 may include one or more ports 26. Ports 26, sometimes referred to as input-output ports, may be physically coupled to one or more external device(s).

In other illustrative arrangements, one or more components such as packet processor 22 may be omitted from device 10, and device 10 may generally be a computing device with other non-networking functions. In other words, port 26 may be contained within a non-networking computing device 10 or generally a computing or electronic system that conveys electrical signals using port 26 with external equipment.

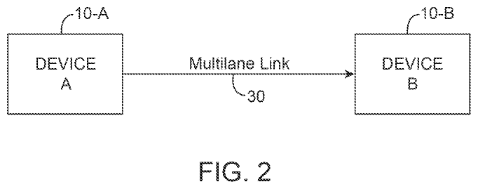

FIG. 2 is a diagram showing two illustrative network devices communicating via a multilane communications link in accordance with some embodiments. As shown in FIG. 2, a first network device such as network device 10-A may be configured to convey data to a second network device such as network device 10-B via one or more multilane links 30. The device transmitting the data can be referred to as the data transmitting device (e.g., network device 10-A can be a data transmitting device), whereas the device receiving the data can be referred to as the data receiving device (e.g., network device 10-B can be a data receiving device).

A multilane link 30 may refer to and be defined herein as a communications channel or pathway that includes multiple lanes or channels for transmitting data in parallel. The multiple lanes can operate concurrently, which allows for increased bandwidth and higher data transfer rates compared to single-lane links. The use of multilane link(s) 30 can help enhance data throughput, improve reliability, and support transmission of large amounts of data (e.g., to provide high bandwidth with low latency). Data may be transmitted over multilane link 30 in accordance with a multilink protocol, sometimes referred to as a multilink communications protocol. Examples of multilink protocols can include the 40G (Gigabit) Ethernet protocol and 100G Ethernet protocol, just to name a few.

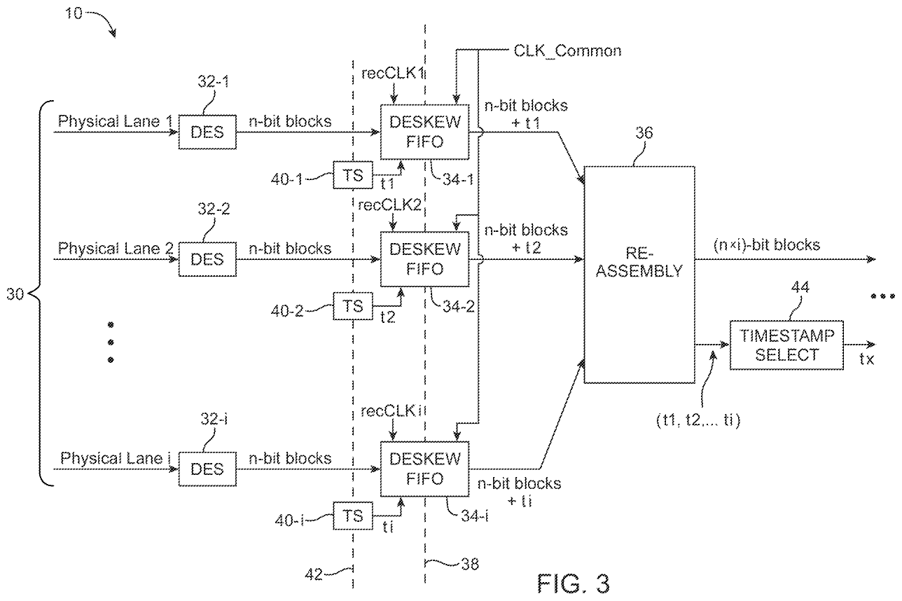

FIG. 3 is a diagram showing receiver circuitry within an illustrative network device 10. The receiver circuitry of device 10 can be configured to receive data via a multilane link 30 and is sometimes referred to collectively as a receiver pipeline. The receiver pipeline can be coupled between a transceiver circuit and a media access control (MAC) layer and can therefore sometimes be referred to as being part of a physical medium attachment (PMA) layer in the physical (PHY) layer. The receiver pipeline can be implemented as part of packet processor 22 or other processing unit within network device 10. As shown in FIG. 3, the receiver pipeline can include deserialization circuits such as deserializers 32, data buffer circuits such as deskew first in, first out (FIFO) buffers 34, a data combining circuit such as data reassembly circuit 36, and other receiver components. Data reassembly circuit 36 is sometimes referred to as a data reassembler or a data reassembling component. The deserialization circuits can receive data via a multilane link 30. Multilane link 30 can represent one or more logical ports or one or more physical ports (see, e.g., input-output ports 26 in FIG. 1).

Multilane link 30 can include i physical lanes. Each physical lane can receive bits serially (e.g., each physical lane can be a serial data lane configured to receive data bits one bit at a time). The i physical lanes can be coupled to i corresponding deserializing circuits 32. For example, a first deserializing circuit 32-1 can be configured to receive serial data bits via a first data lane; a second deserializing circuit 32-2 can be configured to receive serial data bits via a second data lane; . . . ; and an i-th deserializing circuit 32-i can be configured to receive serial data bits via an i-th data lane. As examples, i can be equal to 2, 4, 8, 16, 32, 2-10, 10-20, 20-30, 40-50, more than 10, or other suitable integer for supporting a multilane communications protocol.

Each deserializing circuit 32 can be configured to convert the received serial data bits into corresponding n-bit data blocks on a parallel output data path (e.g., deserializer 32 can convert n serially received data bits into n parallel data bits at its output). As examples, n can be equal to 2, 4, 6, 8, 16, 32, 64, 66, 2-8, 8-16, 16-32, 32-64, 64-128, 128-256, more than 256, or other suitable integer. Each n-bit data block can sometimes be referred to as a data word, data segment, data unit, data chunk, data portion, or data group.

Each deserializer 32 may be coupled to a corresponding deskew FIFO (data) buffer 34. The example of FIG. 3 in which the output of each deserializer 32 is directly coupled to a corresponding deskew FIFO buffer 34 is illustrative. If desired, one or more additional receiver components can optionally be interposed along the receiver path between each deserializer 32 and the corresponding FIFO buffer 34. In FIG. 3, a first deskew FIFO buffer 34-1 can be configured to receive n-bit (parallel) data blocks from the first deserializing circuit 32-1, a second deskew FIFO buffer 34-2 can be configured to receive n-bit data blocks from the second deserializing circuit 32-2, . . . , and an i-th deskew FIFO buffer 34-i can be configured to receive n-bit data blocks from the i-th deserializing circuit 32-i.

The n-bit blocks from each data lane can arrive at the deskew FIFO buffers 34 at different times. Since the data received over multilane link 30 may not contain any clock signals, the receiver pipeline can include a clock recovery mechanism for extracting the timing information from the incoming data. Such a clock recovery mechanism (omitted from FIG. 3 to avoid obscuring the present embodiment) may sample the incoming data to extract corresponding recovered clock signals for each data lane. For example, the n-bit blocks from the first data lane can be latched at the first deskew FIFO buffer 34-1 using a first recovered clock signal recCLK1. The n-bit blocks from the second data lane can be latched at the second deskew FIFO buffer 34-1 using a second recovered clock signal recCLK1. The n-bit blocks from the i-th data lane can be latched at the i-th deskew FIFO buffer 34-i using an i-th recovered clock signal recCLKi.

The receiving network device 10 may, however, employ a local system clock such as clock signal CLK_common that might not be synchronized with the timing of the received data. This phenomenon in which a signal from one clock domain (e.g., the clock domain associated with the transmitting device) is received and processed by a receiving device operating in a different clock domain is sometimes referred to as a clock domain crossing. Dotted line 38 represents a boundary of such clock domain crossing, where the clock domain of the transmitting device crosses into the clock domain of the receiving device. In other words, clock domain boundary 38 separates different clock domains (e.g., separates the local/common clock domain from the plurality of recovered clock domains). Boundary 38 is therefore sometimes referred to as a clock domain boundary or a clock domain crossing (CDC) boundary.

Deskew FIFO buffers 34 disposed along or straddling such clock domain crossing boundary 38 can be configured to provide two separate functions: (1) to remove skew between different lanes of the multilane protocol, and (2) to synchronize data from one clock domain to another (e.g., to ensure proper clock domain crossing). Data from the various deskew FIFO buffers 34 can be read out in parallel using the common (local) clock signal CLK_common. The use of deskew buffers 34 at the clock domain crossing/boundary 38 can thus help simultaneously mitigate clock domain asynchronicity (e.g., to help correct the phase of the received data bits) while compensating for skew among the various data lanes (e.g., to help correct the alignment of data from the various receiver lanes). Operated in this way, the alignment and phase of the received data can be corrected for by buffers 34. This arrangement in which deskew FIFO buffers 34 are configured to provide both data lane deskew/alignment and phase correction in the clock domain crossing is illustrative. In other embodiments, the deskew/alignment of data and the phase correction in the clock domain crossing can be implemented in separate circuits.

Some applications may require the ability to accurately timestamp a specific event of interest within a data stream (e.g., a start of packet) received at network device 10. In practice, however, data being transmitted over a physical network link is typically encoded and/or scrambled in a protocol specific manner, so it can be challenging to identify certain events of interest and to trigger the capture of timestamps at the receiving device 10 until sufficient decoding or descrambling of the data has been performed, which may occur after a clock domain crossing. Some receiver implementations can optionally omit a clock domain crossing entirely.

In the exemplary receiver pipeline arrangement of FIG. 3, the propagation delay across each data lane can be different, so the transmitted data bits can arrive at device 10 both out of alignment (e.g., there can be several bits of offset between the data lanes) as well as out of phase (e.g., the data bit transitions from the different data lanes may be misaligned). As described above, the deskew FIFO buffers 34 can help resolve the phase offset between the different data lanes while simultaneously performing a realignment of the i lanes (e.g., by buffering or holding the data on the lane with the lowest propagation delay until data across all lanes has been aligned). After this point, data from the various lanes can be clocked out by signal CLK_common and subsequently reassembled by circuit 36 into a single data stream. Data output from reassembly circuit 36 can be conveyed to one or more downstream components to perform descrambling, decoding, decryption, error checking, and/or other protocol specific processing to recover the transmitted data (as data packets). It is typically at this point where the receiver can have visibility into events of interest in the recovered data packets.

Having a clock domain crossing boundary 38 can, if care is not taken, introduce challenges for accurately timestamping certain events of interest. The nature of such clock domain crossing results in the time taken to transfer data from one clock domain to another being non-deterministic and thus impossible to identify in advance. Such non-determinism in the timing of data being transferred across the clock domain crossing can introduce significant variability into the timing information when timestamps are added after the clock domain crossing.

In accordance with an embodiment, the receiver pipeline can be provided with circuitry configured to generate or add timestamps prior to the clock domain crossing 38. By timestamping data prior to the clock domain crossing (e.g., before the deskew FIFO buffers 34), any corresponding timestamps are no longer subject to the variability introduced by the clock domain crossing and the deskew FIFO buffers 34. At this point in the receiver pipeline, however, data along the multiple lanes has not yet been reassembled into a single data stream, so it may not be possible to identify certain meaningful events within the incoming data.

To address this challenge, network device 10 may be provided with timestamping subsystems configured to produce a timestamp for every block or word of data on each of the i data lanes at precisely the same point in each lane. In the example of FIG. 3, timestamping (TS) subsystems such as timestamping circuit components 40 can be provided to acquire timestamps for every data block traversing line 42 in the receive path. Timestamping component 40-1 can be configured to acquire a first timestamp t1 for each n-bit data block passing a point along the first data lane intersecting with dotted line 42 (e.g., by timestamping the arrival of the first bit in each n-bit data block in the first data lane prior to being stored in the first deskew buffer). Timestamping component 40-2 can be configured to acquire a second timestamp t2 for each n-bit data block passing a point along the second data lane intersecting with dotted line 42 (e.g., by timestamping the arrival of the first bit in each n-bit data block in the second data lane prior to being stored in the second deskew buffer). Similarly, timestamping component 40-i can be configured to acquire an i-th timestamp ti for each n-bit data block passing a point along the i-th data lane intersecting with dotted line 42 (e.g., by timestamping the arrival of the first bit in each n-bit data block in the i-th data lane prior to being stored in the i-th deskew buffer). If desired, each timestamper 40 can alternatively or additionally timestamp other portions of each arriving data block.

Each timestamp produced by timestamping components 40 in this way therefore matches with a specific data block and can be carried forward through the receiver pipeline along with the associated data block. These timestamps can be transferred through the clock domain crossing (e.g., via the deskew FIFO buffers 34) along with the associated data blocks, where each timestamp is delayed and buffered in the same way as the data block to which it applies. In the example of FIG. 3, n-bit data blocks-along with their associated timestamps-can be simultaneously produced at the output of each deskew FIFO buffer 34 at an edge of the shared clock signal CLK_common. For example, deskew FIFO buffer 34-1 can output a first n-bit data block along with its corresponding timestamp t1 at a given rising edge of CLK_common; deskew FIFO buffer 34-2 can output a second n-bit data block along with its corresponding timestamp t2 at the given rising edge of CLK_common; . . . ; and deskew FIFO buffer 34-i can output an i-th n-bit data block along with its corresponding timestamp ti at the given rising edge of CLK_common. Subsequently produced n-bit data blocks can also be output by the deskew FIFO buffer 34 along with their associated timestamps generated by components 40.

Operated in this way, once the data blocks on each of the i lanes has been transferred to a common clock domain (i.e., the clock domain of the local clock signal CLK_common) and reassembled back into a single data stream using data reassembly circuit 36, there will be i timestamps (e.g., timestamps t1, t2, . . . , and ti) for each group of reassembled data. Data reassembly circuit 36 can thus output (n*i)-bit blocks, each of which can be assembled based on the various n-bit data blocks received from the i data lanes, to one or more downstream circuit(s). With the data stream reassembled, one or more events of interest are now visible. In addition to each data block, the reassembled data stream now also has corresponding timestamps for each block in the data stream. Thus, instead of relying on an event of interest in the reassembled data stream to trigger a timestamped to be captured, it is now possible to simply select from among the group of previously captured timestamps which would effectively correspond to a target event of interest.

An “event of interest” can refer to and be defined herein as any data pattern in the transmitted or reassembled data stream where a user, designer, or application would want to be able to accurately identify the point in time at which it occurs. As an example, an event of interest might correspond to the arrival or detection of a boundary of a data frame or packet (e.g., the start of each Ethernet frame that is being conveyed over the multilane link, the end of each Ethernet frame that is being conveyed over the multilane link, etc.). An event of interest can optionally depend on the multilink communications protocol currently being employed by network device 10. As other examples, an event of interest might correspond to the arrival or detection of a preamble of a data frame, one or more address information in a data frame, payload data, error detection (e.g., checksum) information in a data frame, other data pattern or marker information, or may corresponding to a time when a network connection has been established, when anomalies in traffic patterns are detected, or when certain protocol information has been detected or received.

Data reassembly block 36 can output or pass through all of the timestamps that it receives (e.g., block 36 can forward timestamps t1, t2, . . . , and ti, one for each of the i physical lanes). A timestamp selection circuit such as timestamp selector 44 can then select which of the i timestamps to forward or pass on to the downstream circuit(s). Since the data blocks were transmitted synchronously across all of the physical lanes, and knowing that the data only has meaning once the matching blocks of data from each of the i lanes have been received, timestamp selector 44 can be configured to select the newest timestamp (e.g., to choose the timestamp corresponding to the slowest arriving data block). The newest or most recent timestamp tx represents the buffering or hold (wait) time needed for all the data blocks to arrive at the deskew FIFO buffers so that a corresponding data stream can subsequently be reconstructed. The most recent timestamp tx selected in this way does not depend on the deskew/fill level of the deskew FIFO buffers 34 nor on any physical lane swapping that could occur when rewiring the input-output ports. Operating the receiver pipeline in this way can be technically advantageous and beneficial since the previously captured timestamps are all captured by components 40 at a deterministic point in the receive path (e.g., before the clock domain cross) but selected later by component 44 in the receive path when a meaningful event of interest can be identified. Removing the uncertainty and non-determinism associated with the clock domain crossing can result in more precise and accurate timestamps being captured by device 10.

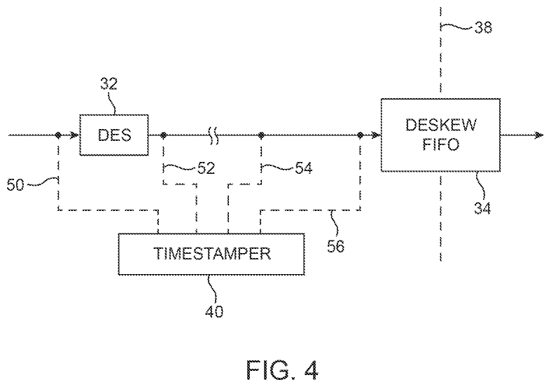

The example shown in FIG. 3 in which the timestamping components 40 are configured to timestamp the arrival of each data block in each data line when a data block crosses dotted line 42 is illustrative. In particular, the timestamping components 40 should be configured to monitor and timestamp data at the same point along each of the multiple data lanes, as long as the point of timestamping is before the cross domain crossing. FIG. 4 is a diagram showing how timestamping can occur at various points along the receiver pipeline. As an example, timestamper 40 can be configured to timestamp the arrival of one or more portions of a data block at the input of deskew FIFO buffer 34 (as shown by dotted line 56). If such a monitoring scheme were adopted, the remaining timestampers 40 would also timestamp the same point in the other data lanes.

As another example, timestamper 40 can be configured to timestamp the arrival of one or more portions of a data block at the output of deserializer 32 (as shown by dotted line 52). If such a monitoring scheme were adopted, the remaining timestampers 40 would also timestamp the same point in the other data lanes. As another example, timestamper 40 can be configured to timestamp the arrival of one or more portions of a data block at the input of deserializer 32 (as shown by dotted line 50). If such a monitoring scheme were adopted, the remaining timestampers 40 would also timestamp the same point in the other data lanes. As yet another example, timestamper 40 can configured to timestamp the arrival of one or more portions of a data block at an intermediate location along the receiver data path between deserializer 32 and deskew FIFO 34 (e.g., there can be one or more receiver components interposed between circuits 32 and 34), as shown by dotted line 54. If such a monitoring scheme were adopted, the remaining timestampers 40 would also timestamp the same point in the other data lanes.

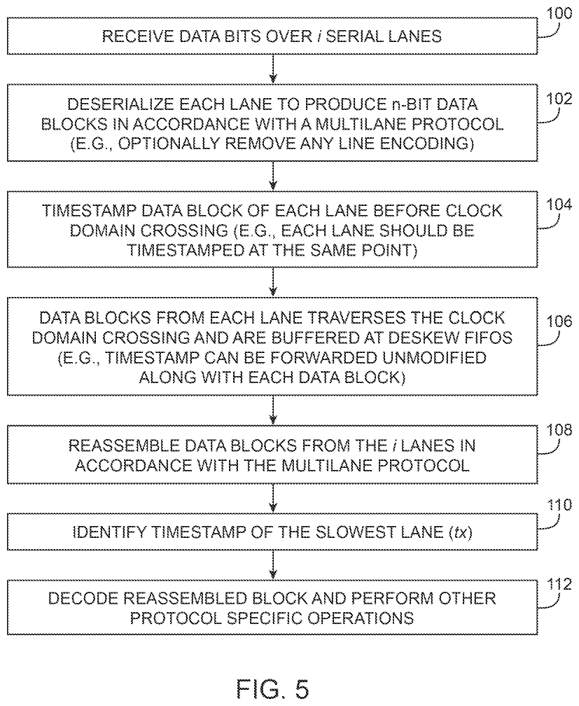

FIG. 5 is a flowchart of illustrative steps for operating receiver circuitry in network device 10 of the type described in connection with FIGS. 1-4. The operations of FIG. 5 can be coordinated using control circuitry 12 of FIG. 1. During the operations of block 100, device 10 can be configured to receive data bits over i serial data lanes. The i serial data lanes can collectively form a multilink lane (see, e.g., multilane link 30 in FIGS. 2 and 3). The multilink lane may serve as one or more physical or logical input-output ports of device 10 (see, e.g., port(s) 26 in FIG. 1). The data bits transmitted over the i serial data lanes may be referred to collectively as a transmitted data stream.

During the operations of block 102, device 10 can be configured to deserialize the serial data bits transmitted over each data line to produce corresponding data blocks in accordance with a multilane (communications) protocol. For example, a deserializer 32 (see FIG. 3) in each physical data lane can convert the received serial data bits into corresponding n-bit data blocks. The deserializers 32 or other receiver component can optionally remove any line encoding during block 102.

During the operations of block 104, device 10 can be configured to timestamp each data block per lane before the clock domain crossing 38. For example, a timestamping component 40 can be configured to timestamp each data block at the same point in the receive path of each data lane. The timestamping components 40 can be configured to monitor or timestamp the arrival of each data block at the input of each deskew FIFO buffer 34, at the output of each deserializer 32, at the input of each deserializer 32, or at other intermediate point along the receive data path (see, e.g., FIG. 4). The timestamping components 40 can sometimes be referred to as timestamping subsystems or timestampers.

During the operations of block 106, the data blocks conveyed over the multiple data lanes can traverse the clock domain crossing by first being buffered at the deskew FIFO circuits 34. The arriving data block in each lane can be latched at a corresponding deskew FIFO 34 using a respective recovered clock signal for that particular data lane. Each deskew FIFO circuit 34 can also receive a timestamp associated with each incoming data block being buffered. The buffered information can be output from each deskew FIFO circuit 34 simultaneously using the local clock signal CLK_common. Operated in this way, each FIFO circuit 34 can output a data block along with an unmodified timestamp. This example in which the FIFO circuits 34 are configured to simultaneously provide both data lane deskew (alignment) function and cross domain crossing (phase correction) function is illustrative. If desired, the two functions can be implemented in separate circuits or components.

During the operations of block 108, device 10 can be configured to reassemble the various data blocks output in parallel from the deskew FIFO buffers 34. For example, data reassembly circuit 36 can reorder, recombine, or otherwise reassemble the data blocks from the i physical lanes to produce a corresponding reassembled data stream having (n*i)-bit blocks in accordance with the multilane protocol with which the data bits are being transmitted over the multilane link. Data reassembly circuit 36 can receive i timestamps along with the i data blocks and pass through those timestamps unmodified.

During the operations of block 110, device 10 can be configured to identify the timestamp of the slowest lane (e.g., tx in FIG. 3). For example, timestamp selection circuit 44 can analyze the i unmodified timestamps and identify a most recent or latest acquired timestamp tx from among the group of i timestamps. The example of FIG. 3 in which timestamp selection circuit 44 is implemented as a separate component from data reassembly circuit 36 is illustrative. If desired, timestamp selection circuit 44 can optionally be implemented as part of data reassembly circuit 36. The example of FIG. 4 in which the operations of block 110 is shown as occurring after the operations of block 108 is also illustrative. In other embodiments, the operations of block 110 can occur before or in parallel (simultaneously) with the operations of block 108.

The reassembled data stream, sometimes referred to as a reassembled data block (which can include n*i data blocks), and the selected timestamp tx can be forwarded to one or more downstream components for further processing. During the operations of block 112, the one or more downstream components can optionally decode the reassembled data stream and perform other protocol specific operations (e.g., descrambling, decryption, and/or other data packet processing functions). With events of interest being visible at this point, each reassembled data block will have a corresponding timestamp tx that was captured prior to the clock domain crossing. Obtaining and selecting timestamps in this way can be technically advantageous and beneficial to improve timestamp accuracy regardless of deskew buffers fill levels or physical lanes ordering.

The operations of FIG. 5 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

In general, network device 10 may be part of a digital system or a hybrid system that includes both digital and analog subsystems. Network device 10 may be used in a wide variety of applications as part of a larger computing system, which may include but is not limited to: a datacenter, a financial system, an e-commerce system, a web hosting system, a social media system, a healthcare/hospital system, a computer networking system, a data networking system, a digital signal processing system, an energy/utility management system, an industrial automation system, a supply chain management system, a customer relationship management system, a graphics processing system, a video processing system, a computer vision processing system, a cellular base station, a virtual reality or augmented reality system, a network functions virtualization platform, an artificial neural network, an autonomous driving system, a combination of at least some of these systems, and/or other suitable types of computing systems.

The methods and operations described above in connection with FIGS. 1-5 may be performed by the components of network device 10 using software, firmware, and/or hardware (e.g., dedicated circuitry or hardware). Software code for performing these operations may be stored on non-transitory computer readable storage media (e.g., tangible computer readable storage media) stored on one or more of the components of the network device. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device (e.g., processor 14, processor 22, and/or control circuitry 12 of FIG. 1).

The foregoing is merely illustrative and various modifications can be made to the described embodiments. The foregoing embodiments may be implemented individually or in any combination.

What is claimed is:

1. A method of operating a network device, comprising:
with a first deserializer, receiving first data bits via a first data lane and outputting a corresponding first data block;
with a second deserializer, receiving second data bits via a second data lane and outputting a corresponding second data block;
generating a first timestamp for the first data block and generating a second timestamp for the second data block;
with a first data buffer coupled to the first data lane and disposed on a clock domain crossing boundary, receiving the first data block and the first timestamp; and
with a second data buffer coupled to the second data lane and disposed on the clock domain crossing boundary, receiving the second data block and the second timestamp.

2. The method of claim 1, further comprising:
with a third deserializer, receiving third data bits via a third data lane and outputting a corresponding third data block; and
with a fourth deserializer, receiving fourth data bits via a fourth data lane and outputting a corresponding fourth data block, wherein the first, second, third, and fourth data bits are transmitted over the first, second, third, and fourth data lanes in accordance with a multilane protocol.

3. The method of claim 1, further comprising:
with a first timestamper, generating the first timestamp for the first data block at a given point along the first data lane; and
with a second timestamper, generating the second timestamp for the second data block at the same given point along the second data lane.

4. The method of claim 1, further comprising:
with the first data buffer, receiving a first recovered clock signal obtained based on the first data bits and receiving a common clock signal.

5. The method of claim 4, further comprising:
with the second data buffer, receiving a second recovered clock signal, different than the first recovered clock signal, based on the second data bits and receiving the common clock signal.

6. The method of claim 5, further comprising:
with the first data buffer, outputting the first data block and the first timestamp in response to detecting an edge in the common clock signal; and
with the second data buffer, outputting the second data block and the second timestamp in response to detecting the edge in the common clock signal.

7. The method of claim 6, further comprising:
with a data reassembly component, receiving the first data block and the first timestamp from the first data buffer and receiving the second data block and the second timestamp from the second data buffer; and
with the data reassembly component, outputting a reassembled data stream based at least partly on the first and second data blocks.

8. The method of claim 7, further comprising:
selecting from between at least the first timestamp and the second timestamp.

9. The method of claim 8, wherein selecting from between at least the first timestamp and the second timestamp comprises identifying a most recent timestamp.

10. The method of claim 9, further comprising:
conveying the reassembled data stream and the most recent timestamp to one or more downstream components in the network device.

11. A network device comprising:
a first deserializing circuit configured to receive first serial data bits and to output a corresponding first data block;
a second deserializing circuit configured to receive second serial data bits and to output a corresponding second data block;
a first data buffer straddling a clock domain crossing boundary and configured to receive the first data block;
a second data buffer straddling the clock domain crossing boundary configured to receive the second data block;
a first timestamping subsystem configured to add a first timestamp for the first data block prior to the first data block being stored in the first data buffer straddling the clock domain crossing boundary; and
a second timestamping subsystem configured to add a second timestamp for the second data block prior to the second data block being stored in the second data buffer straddling the clock domain cross boundary.

12. The network device of claim 11, wherein the first data buffer comprises a first deskew first in, first out (FIFO) buffer and wherein the second data buffer comprises a second deskew first in, first out (FIFO) buffer.

13. The network device of claim 11, wherein the first data buffer is further configured to receive a first recovered clock signal and a local clock signal and wherein the second data buffer is further configured to receive a second recovered clock signal and the local clock signal.

14. The network device of claim 11, further comprising:
a data reassembly circuit configured to produce a reassembled data stream based at least partly on the first and second data blocks output from the first and second data buffers.

15. The network device of claim 11, further comprising:
a third deserializing circuit configured to receive third serial data bits and to output a corresponding third data block;
a fourth deserializing circuit configured to receive fourth serial data bits and to output a corresponding fourth data block;
a third timestamping subsystem configured to add a third timestamp for the third data block;
a fourth timestamping subsystem configured to add a fourth timestamp for the fourth data block; and
a timestamp selection circuit configured to evaluate the first, second, third, and fourth timestamps to identify a timestamp corresponding to a slowest arriving data block among at least the first, second, third, and fourth timestamps.

16. The network device of claim 11, further comprising:
one or more first receiver components coupled between the first deserializing circuit and the first data buffer; and
one or more second receiver components coupled between the second deserializing circuit and the second data buffer.

17. A method of operating a network device, comprising:
receiving data via a plurality of data lanes in accordance with a multilane communications protocol;
conveying the data through a clock domain boundary that separates different clock domains; and
prior to the data traversing the clock domain boundary, producing a plurality of timestamps on the data.

18. The method of claim 17, wherein receiving the data comprises:
with a plurality of deserializers, receiving serial data bits in the data and outputting a plurality of corresponding n-bit data words in parallel.

19. The method of claim 18, wherein conveying the data through the clock domain boundary comprises:
with a plurality of deskew first in, first out (FIFO) buffers, latching the n-bit data words using a plurality of different recovered clock signals and outputting the n-bit data words using a common clock signal separate from the plurality of different recovered clock signals.

20. The method of claim 17, wherein producing the plurality of timestamps on the data comprises timestamping an arrival of the data at a same point in each data lane in the plurality of data lanes.
